(19) United States
(12) Patent Application Publication
(10) Pub. No.: US 2009/0225001 A1
(43) Pub. Date: Sep. 10, 2009

(54) Hybrid Display Systems and Methods

(75) Inventors: Frank Biocca, E. Lansing, MI (US); Jannick Rolland, Orlando, FL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: University of Central Florida Research Foundation, Inc., Orlando, FL (US)

(21) Appl. No.: 12/266,077

(22) Filed: Jan. 16, 2009

Related U.S. Application Data
(60) Provisional application No. 60/985,724, filed on Nov. 6, 2007.
(60) Provisional application No. 61/039,979, filed on Mar. 27, 2008.

(51) Int. Cl. G09G 5/00

(52) U.S. Cl. 345/8

(57) ABSTRACT

In one embodiment, a hybrid display system includes a dome in which a system user may enter, the dome including an inner surface, a projector configured to project a background image on the dome inner surface that the user can view, and a head-mounted display (HMD) that the user can wear, the HMD being configured to display an insert image to the user simultaneous to the projection of the background image so that the user can view a hybrid image comprising both the background image of the dome and the insert image of the HMD.

### CROSS-REFERENCE TO RELATED APPLICATIONS

This application claims priority to copending U.S. provisional application Ser. No. 60/985,724 entitled “AR Aerial Terrain Dome: Hybrid Display for High-Volume, Geo-Operational Visualization and Operational Control” and filed Nov. 6, 2007, and U.S. provisional application Ser. No. 61/039,979 entitled “AR Aerial Terrain Dome: Hybrid Display for High Volume, Geo-Operational Visualization and Operational Control” and filed Mar. 27, 2008.

### BACKGROUND

It is often necessary for persons to review images for the purpose of identifying certain details within those images. For example, in a reconnaissance context, an analyst may be called upon to scrutinize aerial photographs, for instance captured by a satellite, reconnaissance plane, or an unmanned aerial vehicle (UAV), to identify objects of interest on the ground.

In typical situations, such images are reviewed using a conventional computer display, such as a liquid crystal display (LCD) monitor. Unfortunately, the use of such monitors can be disadvantageous. For one thing, the area that can be viewed at any given time is relatively limited. For example, if one were to use a standard 19 inch LCD monitor, only a relatively small area of terrain can be displayed at a scale at which the viewer can clearly identify manmade objects. Although the use of a larger monitor would increase the area that could be viewed, such a monitor still would not provide the viewer with an authentic representation of the viewed scene given that the display is two dimensional and therefore cannot convey spatial relationships that would provide more information to the viewer.

Although immersive displays have been developed that surround the viewer within a large panoramic image, such displays cannot present photographic images in high resolution. Therefore, although improved spatial cognition is provided, the viewer may not be able to discern fine details within the images.

### BRIEF DESCRIPTION OF THE FIGURES

The components in the drawings are not necessarily to scale, emphasis instead being placed upon clearly illustrating the principles of the present disclosure. In the drawings, like reference numerals designate corresponding parts throughout the several views.

FIG. 1 is a schematic view of an embodiment of a hybrid display system.

FIG. 2 is a front view of an embodiment for a display dome used in the hybrid display system of FIG. 1.

FIG. 3 is block diagram of an embodiment for a computer system used in the hybrid display system of FIG. 1.

FIG. 4 is a flow diagram of an embodiment of a method for presenting a hybrid image to a user of a hybrid display system.

FIG. 5A is a depiction of a background image that can be used to form a hybrid image to be presented to a user of a hybrid display system.

FIG. 5B is a depiction of the background image of FIG. 5A after a portion of the image has been attenuated to facilitate integration of an insert image within the background image.

FIG. 5C is a depiction of a hybrid image that results after a high-resolution insert image has been integrated with the background image of FIG. 5B.

### DETAILED DESCRIPTION

As described above, the use of conventional displays, such as computer monitors, may be undesirable for image analysis given their limited size and the fact that they are limited to presenting flat, two-dimensional images. Although immersive displays do not have those limitations, existing immersive displays cannot present high-resolution photographic images, and therefore may be ill-suited for photographic image analysis.

Disclosed herein, are hybrid display systems with which a user can view images in high resolution throughout up to 360 degrees around his or her person. In some embodiments, a hybrid display system comprises a display dome in which the user stands and a see-through head mounted display (HMD) that the user wears while within the dome. In such embodiments background images are projected onto the dome to provide an immersive viewing environment and insert images are presented to the user within the HMD so that hybrid images comprising both the background images and insert images may be simultaneously viewed by the user. In some embodiments, the insert images comprise high-resolution images that are integrated with the background images such that the viewer may view relatively high-resolution images from the HMD within an area of focus (i.e., the area upon which the user's attention is focused) and simultaneously view relatively low-resolution images from the dome peripherally. In further embodiments, the HMD is used to augment the hybrid image with one or more graphical features.

Described in the following are embodiments of hybrid display systems and methods. Although particular embodiments are described, the disclosed systems and methods are not limited to those particular embodiments. Instead, the described embodiments are mere example implementations of the disclosed systems and methods.

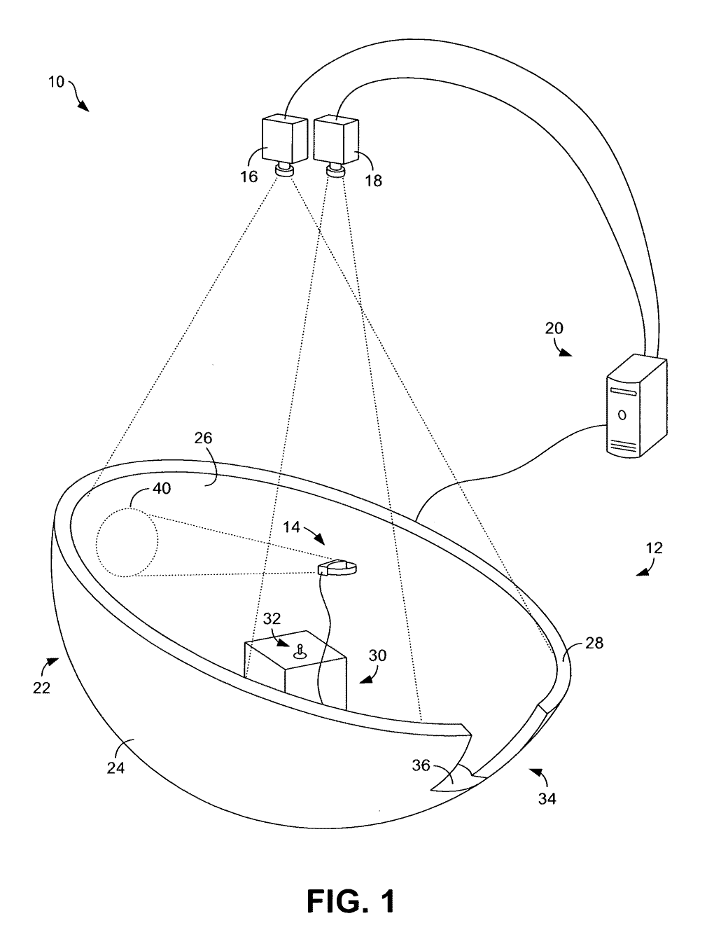

FIG. 1 illustrates an example hybrid display system 10. As indicated in FIG. 1, the system 10 generally comprises a background display 12, a head mounted display (HMD) 14, an image projector 16, a camera 18, and a computer system 20.

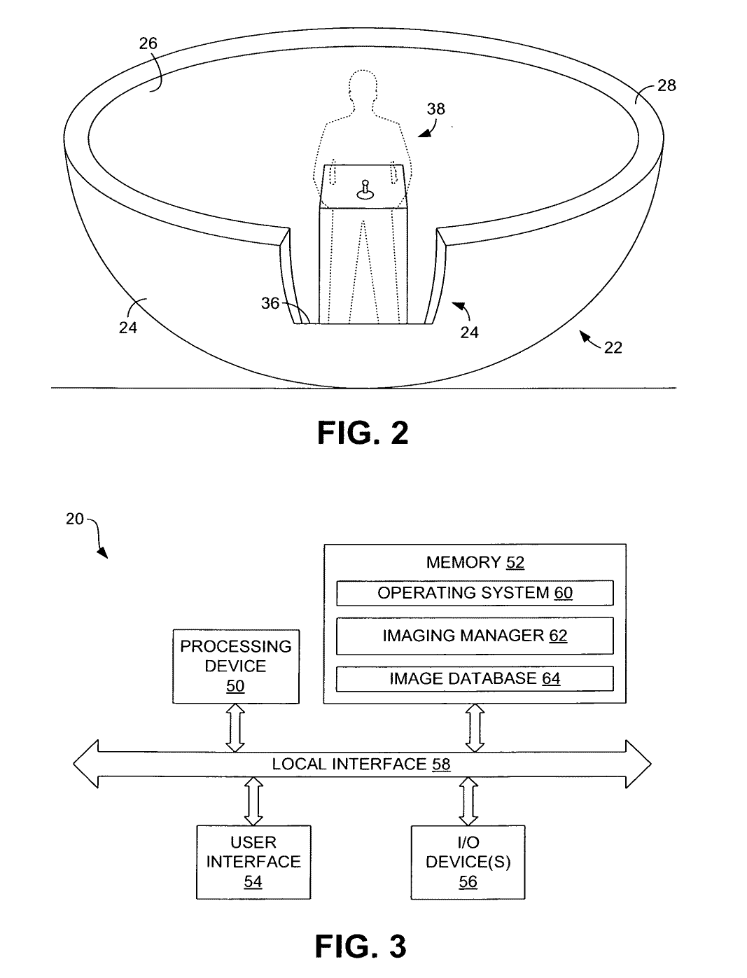

As indicated in both FIGS. 1 and 2, the background display 12 comprises a hollow display dome 22. In the illustrated embodiment, the dome 22 comprises an inverted partial sphere, such as a hemisphere, which includes an outer surface 24, an inner surface 26, and a top edge 28 that separates the outer and inner surfaces. The dome 22 can be tilted or angled such that the top edge 28 is not parallel with the ground or the floor on which the dome rests. By way of example, the top edge 28 forms an angle of approximately 20° to 40° with the horizontal plane. The inner surface 26 of the dome 22 serves as a display surface or screen onto which images generated by the image projector 16 can be projected.

With further reference to FIGS. 1 and 2, the background display 12 can further comprise a control console 30 that is placed within the dome 22. The control console 30 includes one or more user interface devices, such as a joystick controller 32 and one or more keys or buttons (not shown). Such user interface devices can be used for various purposes, such as initiating the system 10, selecting a hybrid image to view, panning or scanning over a displayed hybrid image (e.g., to move to a new geographical area), controlling a UAV that is providing the source images used to create the displayed hybrid image, and the like. As is visible through an entryway 34 of the dome 22 (which may be closed by a door (not shown)), the control console 30 can be mounted to or supported by a floor 36 within the dome 22 and can have a height that approaches the midsection of a user 38 when the user is standing on the floor. In such cases, the control console 30 can, optionally, be grasped by the user 38 as needed to maintain his or her balance while viewing images in the immersed environment of the dome 22. In alternative embodiments, however, the control console 30 can be omitted from the background display 12 to ensure an unobstructed view of the inner surface 26 of the dome 22.

FIG. 2 provides an indication of the scale of the dome 22. As shown in that figure, the dome 22 is large enough for the topmost point of the top edge 28 to be positioned above the typical user 38 when standing upon the floor 36. In such cases, the user 38 can view images projected onto the inner surface 26 of the dome 22 by looking straight ahead. Given that the inner surface 26 surrounds the user 38 when standing near the center of the dome adjacent the control console 30, the user can also view images that are displayed to his or her sides and even behind the user. Therefore, substantially 360° panoramic images can be displayed for the user 38 that provide the user with a strong sense of spatial relationships. By way of example, such a result can be obtained when the dome 22 has a height of approximately 8 to 12 feet and a diameter (as measured along the top edge 28) of approximately 12 to 16 feet. In some embodiments, the hybrid display system 10 is portable and the dome 22 can be deployed as needed. In such cases, the dome 22 can, for example, comprise a collapsible inner frame (not shown) and the inner surface 26 can comprise a flexible screen that can be expanded to cover the inner frame.

With reference back to FIG. 1, the image projector 16, which may be considered to comprise part of the background display 12, is positioned above the dome 22 in a location slightly forward of the position at which the user would stand within the dome (as indicated by the position of the HMD 14). Such positioning avoids the casting of shadows over the portions of the inner surface 26 at which the user is most likely to look. In alternative embodiments, however, the image projector 16 can be positioned elsewhere, such as below the dome 22. The position selected for the image projector 16 is not critical, however, as long as it can effectively project images onto the inner surface 26 of the dome 22.

In the embodiment of FIG. 1, the camera 18 is also positioned above the dome 22. The camera 18 is used to capture images that contain data that indicate the position and orientation of the user's head. Therefore, the camera 18 may be considered to comprise part of a head-tracking system of the hybrid display system 10. More particularly, the camera 18 captures images of light emitting diodes (LEDs) or other markers (not shown) that are provided on the user's head (e.g., on a cap or helmet donned by the user) and/or on the HMD 14 and provides those images to the computer system 20. From those images, the computer system 20 can determine the specific area of the inner surface 26 of the dome 22 at which the user is presumably looking. As described below, that determination enables the presentation of insert images within the HMD 14 that are, from the perspective of the user, in registration with the background images displayed on the dome 22. The insert image is displayed to coincide with the area of the dome 22 (and the background image projected thereon) at which the user's attention is focused, i.e., the area of focus. An example area of focus is depicted in FIG. 1 with an ellipse 40.

As with the image projector 16, the position of the camera 18 is not critical, as long as it can capture the data needed to effectively track the user's head position. In alternative embodiments, the head-tracking system can take other forms. For example, a camera can instead be placed on the user's head and used to capture images of stationary markers on the dome 22 or otherwise provided within the room in which the hybrid display system 10 is used (e.g., on the ceiling). In a further alternative, the user's head position and orientation can be determined using electromechanical sensors.

The HMD 14 can comprise a monocular or stereoscopic HMD. In either case, the HMD 14 comprises its own display device, such as a microdisplay or other display element or apparatus, and optics that are used to deliver images from the display device to one or both eyes of the user. Irrespective of its particular configuration, the HMD 14 is a “see-through” HMD, meaning that the wearer can both view images that are generated by the device as well as see through the HMD to view his or her surroundings. Accordingly, the user can see hybrid images that comprise both portions of the background image projected onto the inner surface 26 of the dome 22 and the insert image generated by the HMD 14. Hence, the background display 12 and the HMD 14 may be considered to together form a hybrid display device.

The computer system 20 is used to control the components of the hybrid display system 10 and/or collect data from them. Therefore, the computer system 20 can be placed in electrical communication with each of the HMD 14, the image projector 16, the camera 18, and the control console 30 (when provided). As depicted in FIG. 1 by a plurality of cables, the computer system 20 can be physically coupled to each of those components with a wired connection. In other embodiments, however, the computer system 20 can be connected to one or more of those components using a wireless connection. Although not shown in FIG. 1, the computer system 20 can also be in electrical communication with a network such that images to be displayed by the hybrid display system 10 can be obtained via a network connection. Such functionality enables the presentation of recently-captured images and/or video. By way of example, real-time images may be obtained from a satellite, reconnaissance plane, or unmanned aerial vehicle (UAV) for display to a user.

FIG. 3 illustrates an example architecture for the computer system 20. As indicated in FIG. 3, the computer system 20 comprises a processing device 50, memory 52, a user interface 54, and at least one input/output (I/O) device 56, each of which is connected to a local interface 58.

The processing device 50 can comprise a central processing unit (CPU) that controls the overall operation of the computer system 20 and one or more graphics processor units (GPUs) for rapid graphics rendering. The memory 52 includes any one of or a combination of volatile memory elements (e.g., RAM) and nonvolatile memory elements (e.g., hard disk, ROM, etc.) that store code that can be executed by the processing device 50.

The user interface 54 comprises the components with which a user (i.e., the user that enters the dome or another user) interacts with the computer system 20. The user interface 54 can comprise the control console 30 mentioned above in relation to FIG. 1 as well as conventional computer interface devices, such as a keyboard, a mouse, and a computer monitor. The one or more I/O devices 56 are adapted to facilitate communications with other devices and may include one or more communication components such as a modulator/demodulator (e.g., modem), wireless (e.g., radio frequency (RF)) transceiver, network card, etc.

The memory 52 (i.e., a computer-readable medium) comprises various programs (i.e., logic) including an operating system 60 and an imaging manager 62. The operating system 60 controls the execution of other programs and provides scheduling, input-output control, file and data management, memory management, and communication control and related services. In some embodiments, the imaging manager 62 comprises the commands that are used to control operation of the HMD 14, the image projector 16, and the camera 18. In addition, the imaging manager 62 collects and analyzes image data (e.g., digital images) captured by the camera 18 for the purpose of identifying the user's head position and orientation and, therefore, for determining the direction of the user's gaze. Furthermore, the imaging manager 62 obtains and manipulates the source images that are to be used to generate the hybrid images to be presented to the user. Therefore, in at least some embodiments, the imaging manager 62 generates or controls the background images to be projected onto the dome 22 and the insert images to be displayed within the HMD 14. As such, the imaging manager 62 may be considered to be the primary control element of the hybrid display system 10.

As is further shown in FIG. 3, the memory 52 of the computer system 20 can store an image database 64 that contains source images that may be used by the imaging manager 62 to generate hybrid images. By way of example, the images can comprise multiple aerial photographs that, when pieced together, form an aggregate image of an expansive geographic area.

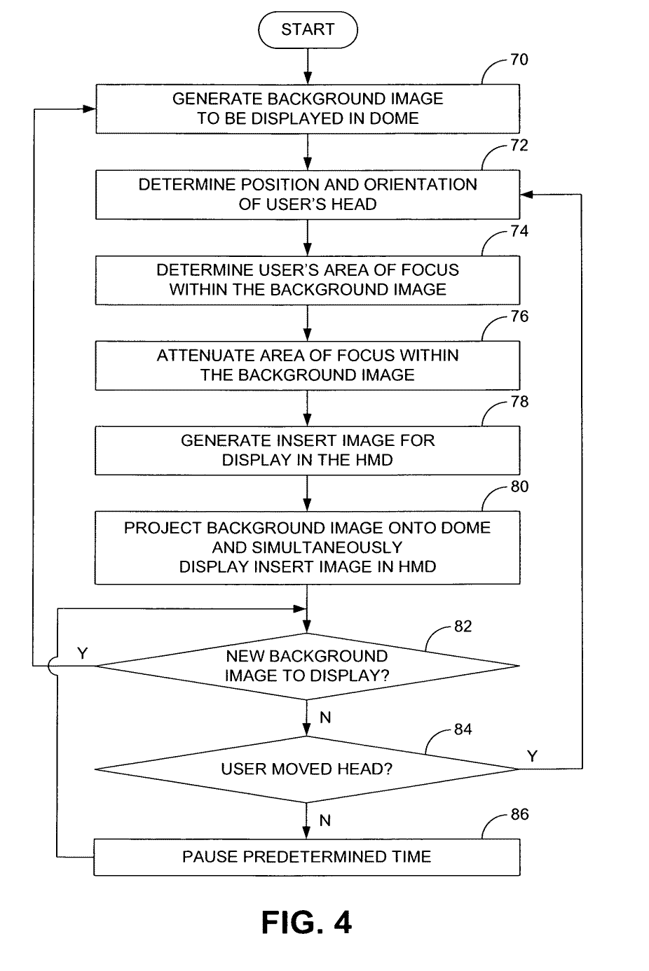

FIG. 4 describes an example of operation of a hybrid display system, such as system 10. The various actions described in relation to FIG. 4 can be performed by or under the control of an imaging manager, such as the imaging manager 62 described above in relation to FIG. 3. In FIG. 4, the images displayed to the user include aerial photographs that have been captured with an image source, such as a satellite, reconnaissance plane, or UAV. It is to be appreciated, however, that the images displayed to a user can comprise substantially any type of image. Therefore, although an aerial terrain implementation is described, it is intended as a mere example that is used to explain the manner in which a hybrid display system can operate.

Beginning with block 70 of FIG. 4, the hybrid display system generates the background image that is to be displayed on the inner surface of the display dome. Presumably, that generation is made relative to a selection (e.g., selection of a geographical area) by the user. Regardless, inherent in the generation of the background image is identifying the one or more source images that are to be used to produce the background image. In some embodiments, source images can be obtained from an image database, such as database 64 identified in relation to FIG. 3. In other embodiments, source images can be obtained via a network directly from the image source. In the latter case, the source images can be up-to-date, or even real-time, images of a given geographical area. Regardless, each background image can comprise a single source image or multiple source images that have been pieced or “stitched” together to form a continuous image of a geographical area. In the latter case, a larger geographical area can be analyzed by the user. As described below, each portion of the terrain can still be presented to the user in high resolution when the HMD 14 is used.

Referring next to block 72, the hybrid display system further determines the position and orientation of the user's head. As described above, that position and orientation can be determined using a suitable head-tracking system, such as one similar to that described in relation to FIG. 1 that captures images of markers provided on the user's head and/or HMD 14. Through the head position/orientation determination, the particular area at which the user's head is directed, and presumably the area at which the user's attention is focused (i.e., the focus area), can be determined, as indicated in block 74. With such information, the system can generate insert images to present in the HMD 14 that will be in registration with the background image. Notably, calibration may need to be performed to ensure that the determined position and orientation, as well as the determined focus area, accurately reflect reality.

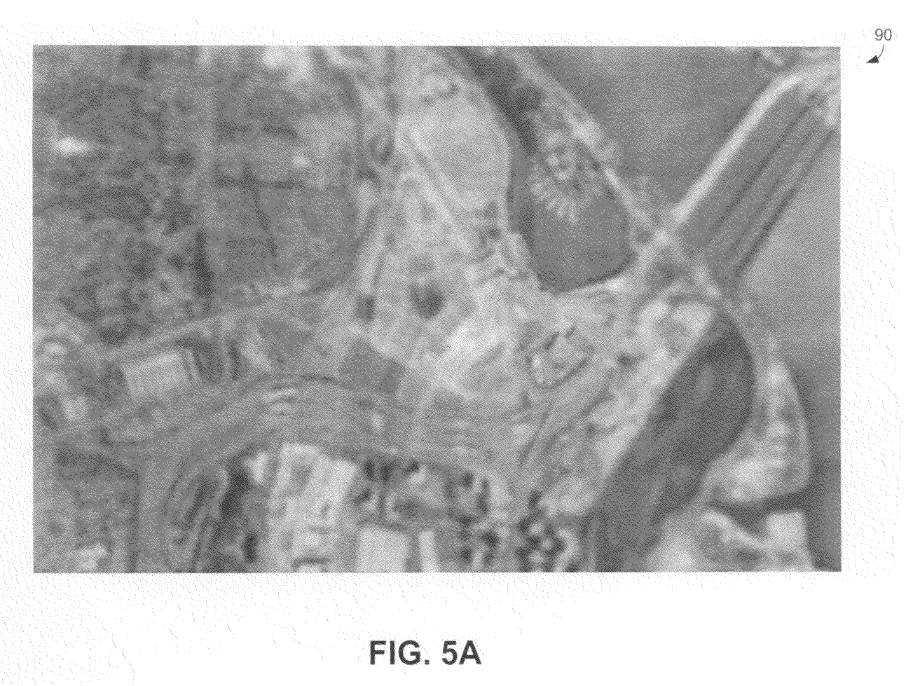

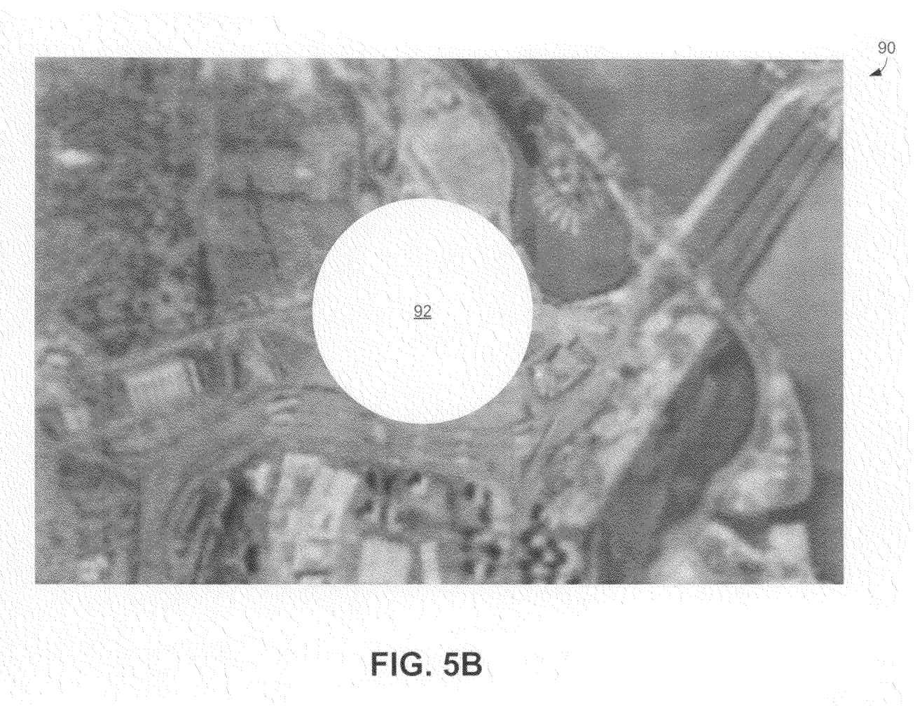

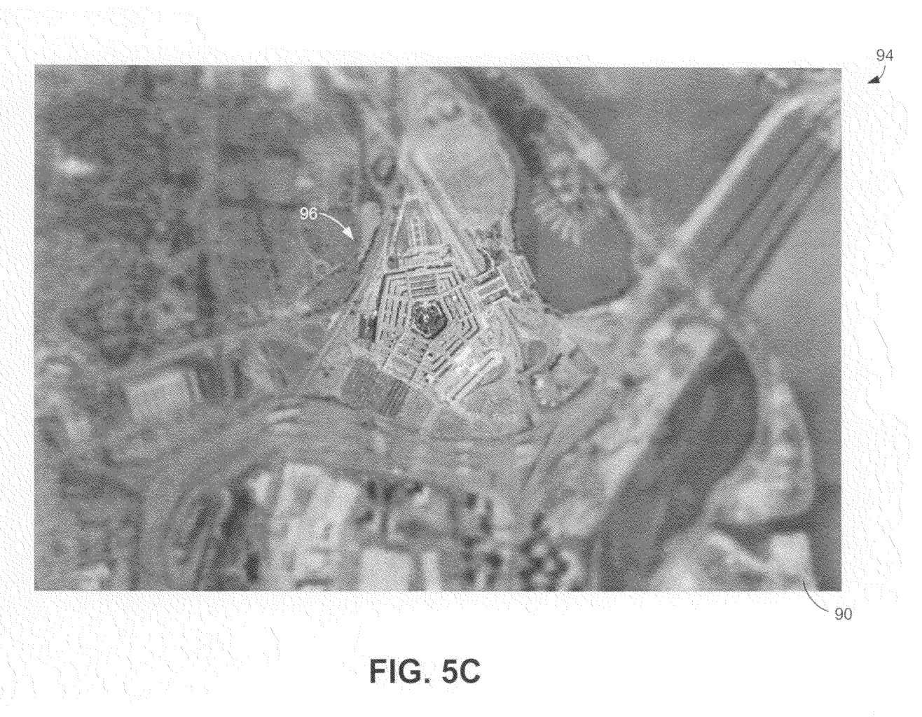

In embodiments in which high-resolution images are to be presented to the user in the HMD 14, it may be necessary to attenuate the area of focus within the background image (block 76) to avoid degrading the HMD's high-resolution images with the relatively low-resolution of the background image. That is, when low-resolution images are overlaid with high-resolution images, the blurriness of the low-resolution images will still be visible to the user and, therefore, the result is an image that appears out of focus. In some embodiments, attenuation can comprise simply blocking out the area of focus within the background image. Such a process is depicted by FIGS. 5A and 5B.

FIG. 5A shows a rectangular portion of an example background image 90 that can be projected onto the inner surface of the display dome. As is apparent from FIG. 5A, the background image 90 is a relatively low-resolution image. That low resolution can be the result of the image projector spreading the background image 90 to display on the expansive inner surface of the dome. In addition or in exception, the low resolution can result from downsampling performed by the projector. For instance, the background image 90 (only a portion of which being represented in FIG. 5A) may be an aggregate image formed of multiple source images captured by an image source (satellite, reconnaissance plane, or UAV). In such a case many of the captured pixels may need to be discarded to display the aggregate image within the confines of the dome. To cite a hypothetical example, assume the image capture element of the image source has a resolution of 1000×1000 pixels and that 10 captured images are used to form an aggregate background image. In such a case, there are 10 million pixels available for display. If the display element of the image projector 16 also has a resolution of 1000×1000 pixels, however, only 1 million pixels can be displayed at a time, resulting in the loss of 9 million pixels of image data and a 10-fold drop in resolution. Turning to FIG. 5B, the determined area of focus 92 within the background image 90 has been attenuated by simply blocking or cutting out the area of the background image that corresponds to that area of focus, resulting an a blank space. By so blocking out the area of focus within the background image 90, the relatively low resolution of the background image will not interfere with the relatively high resolution of the insert image to be provided by the HMD.

It is noted that attenuation may not require blocking the area of focus in the manner depicted in FIG. 5B. In alternative embodiments, the area of focus within the background image can instead be dimmed. For example, the area of focus within the background image can be progressively dimmed (e.g., using a Gaussian function) from the outer boundary of the area of focus toward its center. Such a progression can reduce the apparent boundary between the background image and the insert image and therefore provide for smooth edge blending. In yet another alternative, the area of focus within the background image can be attenuated using the HMD. For example, a physical blocking or dimming element can be added to the HMD within the user's field of vision so that the HMD is not, or is less, transparent at the position at which the user views the high-resolution insert image.

With reference next to block 78 of FIG. 4, the system generates the insert image for display in the HMD. As described above, the insert image can comprise a high-resolution image of the area of focus that is to be integrated with the relatively low-resolution background image. High-resolution images can be displayed by the HMD given that the HMD need not spread or downsample source image data to the degree that the image projector does. By way of example, the HMD 14 need only display an image area that results from a 20° field of view. Given that the area of focus comprises only a portion of the entire background image, the HMD may, in some embodiments, be able to utilize the data from each pixel of the image source. In some embodiments, the resolution of the image displayed by the HMD is approximately 1 to 4 arc minutes.

Notably, the insert image to be displayed by the HMD need not comprise, or need not only comprise, a high-resolution image of the area of focus. For example, the insert image may comprise graphical features such as map markings (e.g., political boundaries, a distance scale, etc.), object labels, and other features that are to be overlaid onto the insert and/or background image. In addition or alternatively, the insert image can comprise features that can be selected or otherwise manipulated by the user. For example, onscreen buttons can be presented that the user can select using his or her hands, assuming that the hands, like the head, are tracked by a suitable tracking system. As a further example, a marker feature can be presented that enables the user to tag details within the viewed hybrid image as objects of interest. Of course, many other such features can be presented in the insert image in an augmented reality context, either alone or in combination with a high-resolution image for the area of focus.

With reference next to block 80, the background image is projected onto the dome and the insert image is displayed in the HMD to present a hybrid image to the user. FIG. 5C depicts an example hybrid image 94 that results when the modified background image 90 of FIG. 5B is merged with a high-resolution insert image 96 from the HMD. As indicted in FIG. 5C, the high-resolution insert image 96 is displayed so as to coincide with the attenuated area of focus 92 of the background image 90 (FIG. 5B). As a result, the portion of the hybrid image 94 at which the user is presumably looking is presented in high resolution. Simultaneously, however, the user may still see the background image 90 with his or her peripheral vision. As can be appreciated from comparison of FIG. 5A with FIG. 5C, much more detail can be discerned when the high-resolution insert image 96 is integrated with the background image 90. In this example, the details of the U.S. Pentagon building can be clearly identified in FIG. 5C, whereas the building is nearly unidentifiable from the low-resolution image of FIG. 5A.

Referring next to decision block 82 of FIG. 4, it is determined whether there is a new background image to display. Although a single background image can be projected onto the dome the background image may need to be intermittently changed. For example, if multiple images are being displayed in sequence as they are received from an image source, a new background image, and therefore a new hybrid image, will be displayed to the user. As another example, the user may signal the hybrid display system to display an image of a new geographical area, for instance a geographical area just beyond the edge of the currently displayed background image. In either case, flow returns to block 70 and a new background image is generated.

If a different background image is not to be displayed, however, flow continues to decision block 84 at which it is determined whether the user has moved his or her head. If so, the insert image may need to be updated to reflect a new area of focus. In addition, if the area of focus of the background image is to be attenuated, it too may need to be updated. In such a situation, flow returns to block 72, at which the new position and orientation of the user's head are determined and flow continues thereafter in the same manner as that described above. If, on the other hand, the user has not significantly moved his or her head, for instance if the user is carefully studying a particular area of the hybrid image, the system pauses for a predetermined period of time (e.g., a fraction of a second to a few seconds), as indicated in block 86, and flow returns again to decision block 82.

As can be appreciated from FIG. 4, the hybrid display system can continually track the user's head and, based upon its position and orientation, continually update a hybrid image (i.e., background and insert images) based upon the presumptive direction of the user's gaze. Operating in that manner, the user can carefully scrutinize very large images, and potentially very large areas of terrain, in high resolution. In addition, because an HMD is used, the images that the user sees can be augmented with a variety of graphical features that may assist the user in conducting his or her analysis.

A hybrid display system can comprise various functionalities not described in relation to FIG. 4. In some embodiments, it may be possible for the user to pan or scan across a displayed hybrid image and “navigate” to a new geographical area using body gestures. In some embodiments, such navigation can be achieved by utilizing the head-tracking system. For example, if the user wishes to navigate to a new area of terrain, the user can, for instance, signal such a desire by depressing an appropriate button on the control console or displayed by the HMD, and then leaning his or her body in the direction of the terrain the user wishes to view. Alternatively, the user could point to the direction of the terrain using a hand, assuming the position and orientation of user's hands and/or fingers are being tracked.

In a further alternative, more than one user can enter the display dome. In such a situation, the same background image can be displayed on the inner surface of the dome, but the user's heads can be separately tracked so that different insert images can be displayed within each user's HMD. That way, each user can be presented with high-resolution images for their respective areas of focus on the background image. Furthermore, different features can be displayed to each user depending upon their particular role or responsibilities. For example, if one user were not only viewing the images captured by a UAV but was also controlling the UAV, that user could be provided with an augmented insert image that comprises information that would assist the user in that endeavor, such as UAV altitude, airspeed, and heading. If the other user were acting in the capacity of a gunner (assuming the UAV carried weapons), that user could be provided with an augmented insert image that contains targeting information and launching controls.

In other embodiments, multiple domes may be simultaneously used by multiple users in a coordinated effort. In such a situation, a group leader can be designated and hand signals made by the group leader can be tracked and an associated message can be displayed to each other member of the group in their respective HMDs.

In still further embodiments, eye tracking can be incorporated into the hybrid display system. In some cases, tracking can be used as a means of identifying areas of interest. For example, the user could look at a particular feature within a high-resolution insert image and simultaneously select a button to indicate that whatever the user is looking at is to be tagged by the system. Alternatively, eye tracking can be used to generate a record of the areas of an image that have been reviewed by the user. With such a record, areas that the user missed or reviewed too quickly can be identified and highlighted as possible areas to double check.

1. A hybrid display system comprising:
a dome in which a system user may enter, the dome including an inner surface;
a projector configured to project a background image on the dome inner surface that the user can view; and
a head-mounted display (HMD) that the user can wear, the HMD being configured to display an insert image to the user simultaneous to the projection of the background image so that the user can view a hybrid image comprising both the background image of the dome and the insert image of the HMD.

2. The system of claim 1, wherein the dome comprises a hollow, inverted partial sphere.

3. The system of claim 2, wherein the dome is hemispherical.

4. The system of claim 1, wherein the dome is tilted such that a top edge of the dome is not parallel with the horizontal plane.

5. The system of claim 1, wherein the inner surface surrounds the user such that a substantially 360° panoramic image can be presented to the user.

6. The system of claim 1, wherein the projector is positioned above the dome.

7. The system of claim 1, wherein the projector is further positioned forward of the user to avoid casting shadows within the user's line of sight.

8. The system of claim 1, wherein the HMD is a see-through HMD.

9. The system of claim 1, wherein the HMD is configured to display a high-resolution insert image in registration with the background image, the high-resolution insert image having a higher resolution than the background image.

10. The system of claim 9, wherein the high-resolution insert image has a resolution of approximately 1 to 4 arc minutes.

11. The system of claim 1, wherein the insert image overlays only a portion of the background image.

12. The system of claim 11, wherein the insert image covers an area of the background image that corresponds to an approximate 20° field of view.

13. The system of claim 1, wherein the HMD is configured to display graphical features within the insert image.

14. The system of claim 13, wherein the HMD is configured to display the graphical features in registration with the background image.

15. The system of claim 1, further comprising a control console provided within the dome.

16. The system of claim 1, further comprising a head-tracking system, the head-tracking system being configured to determine the position and orientation of the user's head so that the portion of the dome inner surface, and background image, at which the user is presumably looking can be determined.

17. The system of claim 16, wherein the head-tracking system comprises a camera that captures images of the user.

18. The system of claim 1, further comprising a computer system that controls operation of the hybrid display system.

19. The system of claim 18, wherein in the computer system is configured to determine the portion of the dome inner surface, and background image, at which the user is presumably looking and, based upon that determination, control the insert image displayed in the HMD such that the insert image is in registration with the background image displayed on the dome inner surface.

20. A hybrid display system comprising:
an inverted dome in which a user can enter, the dome including an inner surface that surrounds the user so as to be capable of displaying substantially 360° panoramic images to the user;
a projector positioned above the display dome and forward of the user, the projector being configured to project a relatively low-resolution background image on the dome inner surface for the user to view;
a see-through head-mounted display (HMD) that the user can wear, the HMD being configured to display relatively high-resolution insert images to the user simultaneous to the projection of the relatively low-resolution background image so that the user can view a hybrid image comprising both the relatively low-resolution background image of the dome and the relatively high-resolution insert image of the HMD;
a head-tracking system configured to determine the position and orientation of the user's head; and
a computer system configured to determine the portion of the dome inner surface, and background image, at which the user is presumably looking based upon the head position and orientation determination and to control the high-resolution insert image to coincide and be in registration with the portion of the background image at which the user is presumably looking.

21. The hybrid display system of claim 20, wherein the insert image has a resolution of approximately 1 to 4 arc minutes.

22. The hybrid display system of claim 20, wherein the insert image covers an area of the background image that corresponds to an approximate 20° field of view.

23. The hybrid display system of claim 20, wherein the HMD is further configured to augment the insert image with graphical features.

24. The hybrid display system of claim 23, wherein the HMD is configured to display the graphical features in registration with the background image.

25. A method for displaying a hybrid image to a user, the method comprising:
generating a background image to be displayed on a surface of a dome in which the user is positioned;
generating an insert image for display in a see-through head-mounted display (HMD) that the user is wearing; and
projecting the background image onto the dome surface and simultaneously displaying an insert image to the user in the HMD such that the user can view a hybrid image that comprises both the background image and the insert image.

26. The method of claim 25, wherein generating a background image comprises generating a background image using one or more aerial photographs.

27. The method of claim 25, wherein generating an insert image comprises generating a high-resolution insert image that corresponds to the portion of the background image at which the user is presumably looking.

28. The method of claim 27, further comprising determining the portion of the background image at which the user is presumably looking.

29. The method of claim 28, wherein determining the portion of the background image at which the user is presumably looking comprises determining a position and orientation of the user's head.

30. The method of claim 25, wherein generating an insert image comprises generating a graphical feature that will overlie the hybrid image.
